(19) United States
(12) Patent Application Publication
(10) Pub. No.: US 2016/0114439 A1
(43) Pub. Date: Apr. 28, 2016

(54) Method of Making a Heat Exchanger Using Additive Manufacturing and Heat Exchanger

(71) Applicant: Goodrich Corporation, Charlotte, NC (US)

(72) Inventors: Debabrata Pal, Hoffman Estates, IL (US); Shawn Karl Reynolds, Byron, IL (US); John Horowy, Rockford, IL (US); Charles Shepard, DeKalb, IL (US); Eric Karlen, Rockford, IL (US)

(21) Appl. No.: 14/520,705

(22) Filed: Oct. 22, 2014

(51) Int. Cl. B23P 15/26; F28F 3/02

(52) U.S. Cl. CPC B23P 15/26; F28F 3/02

(57) ABSTRACT

A method of making a component of a heat exchanger includes the steps of providing a substrate, performing a first printing step to add one or more heat-transfer-enhancing structures onto a first side of the substrate, and performing a second printing to add one or more heat-transfer-enhancing structures onto a second side of the substrate. A heat exchanger is also disclosed.

### TECHNICAL FIELD

This application relates to a heat exchanger made by an additive manufacturing process.

### BACKGROUND

Heat exchangers such as cold plates can be formed by subtractive manufacturing processes. For example, a metallic block may be provided and cooling channels can be formed in the metallic block by removing material.

Additionally, heat exchangers can include multiple parts such as first and second sides, mounting blocks, etc. These multiple parts can be attached together by brazing, in one example.

### SUMMARY

A method of making a component of a heat exchanger includes the steps of providing a substrate, performing a first printing step to add one or more heat-transfer-enhancing structures onto a first side of the substrate, and performing a second printing step to add one or more heat-transfer-enhancing structures onto a second side of the substrate.

A heat exchanger includes first and second sides and a central portion arranged between the first and second sides. The central portion includes first and second sets of heat-transfer-enhancing features. The first and second sets of heat-transfer-enhancing features are formed by an additive manufacturing process.

These and other features may be best understood from the following drawings and specification.

### BRIEF DESCRIPTION OF THE DRAWINGS

FIG. 1 schematically shows a prior art heat exchanger made by a subtractive manufacturing process.

FIG. 2 schematically shows a heat exchanger of the present disclosure made by an additive manufacturing process.

FIG. 3A shows a section view of the heat exchanger of FIG. 2 along the line 3A.

FIG. 3B shows a close-up view of a portion of the heat exchanger of FIG. 3A.

FIG. 4 schematically shows a method of making a heat exchanger by an additive manufacturing process.

FIG. 5 schematically shows an additive manufacturing tool making a component of the heat exchanger.

### DETAILED DESCRIPTION

FIG. 1 schematically shows a prior art heat exchanger 8 made by a subtractive manufacturing process. In this example, the prior art heat exchanger 8 is a cold plate. The prior art heat exchanger 8 includes first and second sides 10 and 12, respectively. One or both of the first and second sides 10, 12 can include mounting bosses 14. The second side 12 includes heat-transfer-enhancing structures such as fins 16 with cooling channels 18 between the fins 16. The fins 16 extend from the first side 10 to the second side 12.

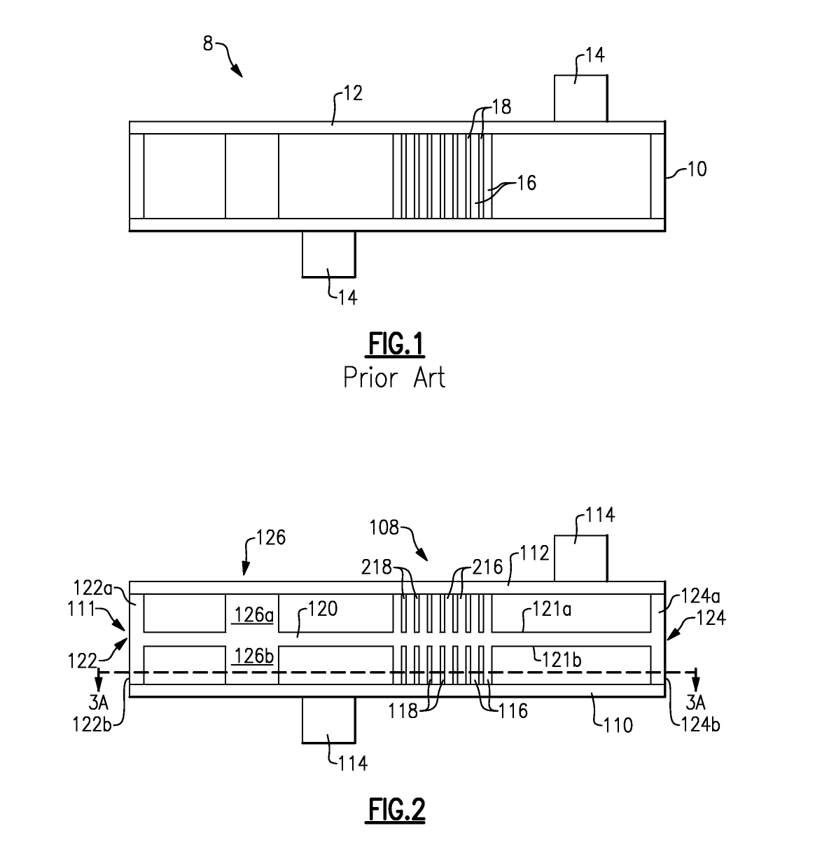

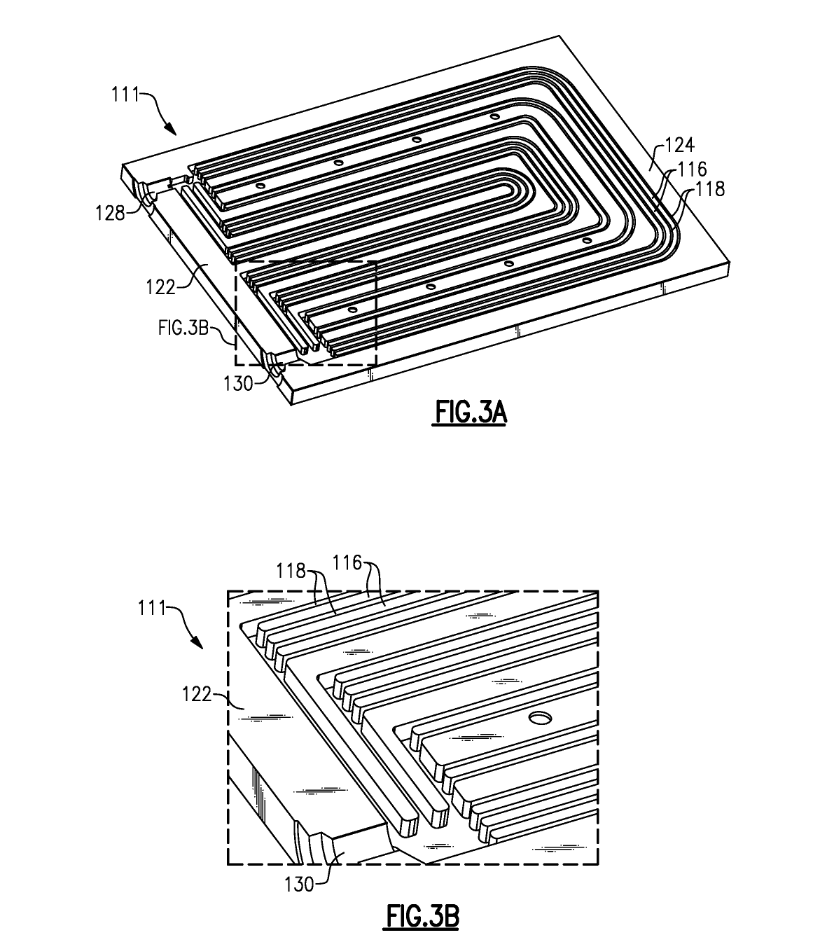

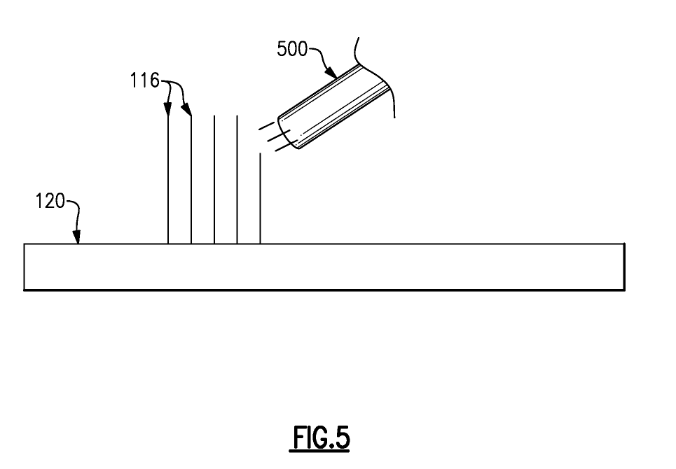

FIG. 2 schematically shows a heat exchanger 108 of the present disclosure made by an additive manufacturing method. The additive manufacturing method is shown schematically in FIG. 4 and is described in detail below.

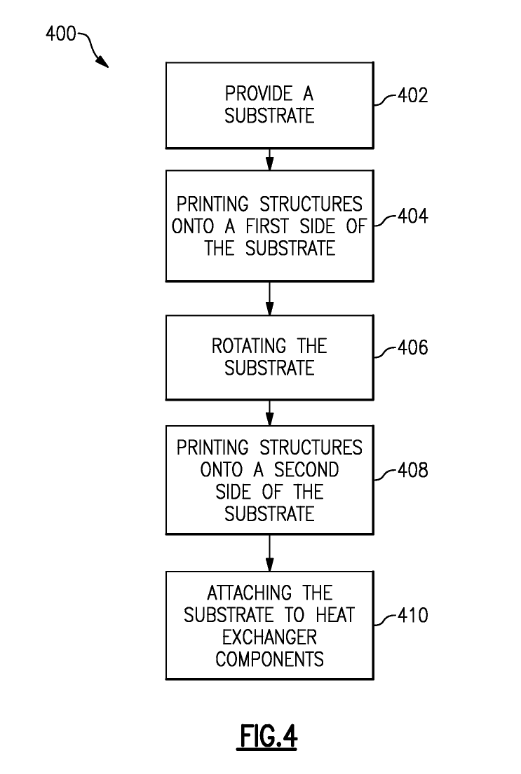

FIG. 3A shows a section view of the heat exchanger 108 along the line 3A. FIG. 3B shows a close-up view of a portion of the heat exchanger as is shown in FIG. 3A.

The heat exchanger 108 is a cold plate in the example of FIGS. 2-3B. However, in another example, the heat exchanger 108 can be another type of heat exchanger.

The cold plate 108 includes first and second sides 110 and 112, respectively, and a center portion 111. One or both of the first and second sides can include mounting bosses 114. The center portion 111 includes a central plate 120 and structural components such as first and second side plates 122, 124. The side plates 122, 124 each include first and second halves 122a, 122b and 124a, 124b, respectively. The center portion 111 can also include one or more structural blocks 126. The block 126 includes first and second halves 126a, 126b. Finally, the center portion 111 includes heat-transfer-enhancing structures. In this example, the heat-transfer-enhancing features are first and second sets of fins 116, 216. In between the fins 116, 216 are first and second sets of cooling channels 118, 218, respectively.

The cold plate 108 includes an inlet 128 and an outlet 130 in the first side plate 122 (FIGS. 3A-B) for fluid to enter the cold plate 108 and remove heat from an electrical component, in one example.

FIG. 4 schematically shows a method 400 of making a component of a heat exchanger by an additive manufacturing process. Step 402 includes providing a substrate. In one example, the substrate can be the central plate 120 of the heat exchanger in FIG. 2.

Step 404 includes printing structures onto a first side of the substrate. For example, the first halves 122a, 124a, and 126a of the first side plate 122, second side plate 124, and optional block 126 and/or the first set of fins 116 can be printed onto a first side 121a of the central plate 120 (FIG. 2) in Step 404. The printing can be accomplished by any additive manufacturing process, such as electron beam free form (EBF3) manufacturing, laser engineering net shape (LENS) manufacturing, or direct metal laser sintering (DMLS). FIG. 5 schematically shows an example additive manufacturing tool 500, such as a laser, which can print a component by any of the additive manufacturing techniques described above or another additive manufacturing technique. In the example of FIG. 5, the additive manufacturing tool 500 is printing one of the first set of fins 116 onto the central plate 120. However, in another example, the tool 500 can print any of the structures described herein.

Referring again to FIG. 4, Step 406 includes rotating the substrate. In one example, the substrate is rotated 180° to expose a second side of the substrate. For instance, the central plate 120 of FIG. 2 can be rotated along its long axis to expose a second side 121b for printing in Step 408. This step of rotating the substrate prior to Step 408 allows objects larger than the maximum aspect ratio limitation of the chosen additive manufacturing process to me made, since only half of the structures need to be printed at a time.

Step 408 includes printing structures onto a second side of the substrate. For example, the second halves 122b, 124b, and 126b of the first side plate 122, second side plate 124, and optional block 126 and/or the second set of fins 216 can be printed onto a second side 121b of the central plate 120 of FIG. 2 in Step 408. Again, the printing can be accomplished by any additive manufacturing process, such as electron beam free form (EBF3) manufacturing, laser engineering net shape (LENS) manufacturing, or direct metal laser sintering (DMLS). The tool 500 of FIG. 5 can be used for Step 408, in one example.

Step 410 includes attaching the substrate to other components of a heat exchanger, such as a housing and/or mounting bosses. The attaching can be accomplished by ultrasonic welding, friction stir welding, or another method. For instance, the central plate 120 and printed first and second side plates 122, 124, optional block(s) 126, and first and second sets of fins 116, 216 can be attached to the first and second sides 110, 112 of the heat exchanger 108 of FIG. 2. Mounting bosses 114 can also be attached to one or both of the first and second sides 110, 112 in this step as well.

Although an embodiment of this invention has been disclosed, a worker of ordinary skill in this art would recognize that certain modifications would come within the scope of this disclosure. For that reason, the following claims should be studied to determine the true scope and content of this disclosure.

1. A method of making a component of a heat exchanger, comprising:
providing a substrate;
performing a first printing step to add one or more heat-transfer-enhancing structures onto a first side of the substrate; and
performing a second printing step to add one or more heat-transfer-enhancing structures onto a second side of the substrate.

2. The method of claim 1, wherein the heat-transfer-enhancing structures are fins.

3. The method of claim 2, wherein the fins include a first set of fins printed on the first side of the substrate in the first printing step and a second set of fins printed on the second side of the substrate in the second printing step.

4. The method of claim 1, further comprising rotating the substrate to expose the second side prior to the second printing step.

5. The method of claim 1, wherein at least one of the first and second printing steps is accomplished by one or electron beam free form (EBF3) manufacturing, laser engineering net shape (LENS) manufacturing, and direct metal laser sintering (DMLS).

6. The method of claim 1, wherein the component is a first component, and further comprising attaching the first component to a second component.

7. The method of claim 6, wherein the attaching is accomplished by one of ultrasonic welding and friction stir welding.

8. The method of claim 6, wherein the first component is a central portion of the heat exchanger.

9. The method of claim 8, wherein the second component is one of a side of the heat exchanger and a mounting boss.

10. The method of claim 1, further comprising printing a first half of a structural component onto the substrate during the first printing step and a second half of the structural component onto the substrate during the second printing step.

11. The method of claim 11, wherein the structural component is one of a side plate and a block.

12. A heat exchanger, comprising:
first and second sides; and
a central portion arranged between the first and second sides, the central portion including first and second sets of heat-transfer-enhancing features, wherein the first and second sets of heat-transfer-enhancing features are each sequentially formed by an additive manufacturing process.

13. The heat exchanger of claim 12, wherein the first and second set of heat-transfer-enhancing features are first and second sets of fins, the first and second sets of fins extending from the central portion to the first and second sides of the heat exchanger, respectively.

14. The heat exchanger of claim 12, further comprising first and second plates extending between the first and second sides, one of the first and second side plates including an inlet and an outlet.

15. The heat exchanger of claim 12, wherein at least one of the first and second sides includes at least one mounting boss.
